(19) United States
(12) Patent Application Publication
(10) Pub. No.: US 2019/0307100 A1
(43) Pub. Date: Oct. 10, 2019

(54) Gastropod Pet Shelter

(71) Applicant: Brian Williams, Bristol, CT (US)

(72) Inventor: Brian Williams, Bristol, CT (US)

(21) Appl. No.: 16/379,750

(22) Filed: Apr. 9, 2019

Related U.S. Application Data
(60) Provisional application No. 62/655,035, filed on Apr. 9, 2018.

(51) Int. Cl. A01K 1/03

(52) U.S. Cl. CPC A01K 1/033; A01K 1/032

(57) ABSTRACT

A pet shelter providing a naturalized habitat for exploiting the instinctual behavior of animals such as dogs, cats and rabbits is disclosed. The pet shelter includes a structure having exterior and interior features of a gastropod shell. The features include an opening defining an entryway configured to receive an animal, a spiral-shaped corridor traversing an interior space of the structure, and a den within the interior space of the structure providing a resting area for an animal. The pet shelter also provides a user the ability to control interior airflow and lighting, and manage pet house training and whelping.

### FIELD OF THE DISCLOSURE

The invention relates generally to a shelter for pets, such as dogs, cats, and rabbits. More particularly, the invention pertains to a kit and/or prefabricated shelter/refuge that provides, amongst other things, a dark and confined denning space with a hidden entryway providing security and comfort to pets.

### BACKGROUND OF THE INVENTION

Dogs, for instance, by nature prefer small, dark, enclosed spaces that provide both mental and physical comfort, offering, enclosed, tight entryways and interior security. Experts have provided guidance to pet owners impressing upon them to aid these natural tendencies by providing, for example, a pet bed in a corner of a room. Some comfort in these situations is provided to a pet, however, the openness of the bed to the environment leaves the corner insubstantial and non-ideal for providing the habitat that the animal's instinct dictates. As such, the animal's instinctual behavior encourages them to seek a den-like shelter that is secluded and has no more room than is required to lie stretched out. When an animal, such as a dog or rabbit, burrows within a cavity in its natural environment, the animal's body heat warms the surrounding area. A portion of the habitat retains the heat and acts as an insulator from the outside air temperature, while the entryway itself provides controlled air flow and venting. Experts also cited that covered habitats provide the pet a sense of safety and security. Open crates and cages—e.g., plastic crates, wire kennels, and the like, do not provide the pet such an environment, and accordingly, many experts recommend covering cages with a blanket to provide a draft-free and safe-feeling place for pets. Many experts agree that dogs, in particular, may prefer draft-free spaces for retreat. Animal behaviorists cite that the pet's refuge to den-like structures aids in the reduction of personality problems and negative behaviors such as howling when left alone in the home.

Denning is a natural instinct in dogs and, as an example, explains their tendency to burrow under blankets. Shelter that can be provisioned with items such as blankets, toys, etc. not only provides comfort and satisfaction of such natural behaviors, but also provides the pet a sense of territorial security. Furthermore, for house training, some animals respond better if litter, food, and water are contained within the den, while others are more easily trained if food, water, and litter (if necessary) is kept outside of the den. As such, a shelter structure that can be easily configured to accommodate various pet personalities would be ideal for pet owners. Lastly, pet habitats should preferably be adaptable to the animal's size and have easy access for maintaining its cleanliness in order to encourage sustained use by the pet.

Pet shelters such as those disclosed in U.S. Pat. No. 7,578,264 to Guard and U.S. Pat. No. 9,107,386 to Roberts provide a dish shaped and shell-shaped structure, respectively, having a generally circular opening for access by a pet. Such structures, however, are not ideal for denning animals as the sleeping area is exposed to excessive light and perceived encroachment by outsiders. Pet habitats that provide reduced encroachment threat are preferable. Other structures, such as the pet enclosure disclosed in U.S. Patent Application No. 20080066686A1 to Jordan and Lockwood, cater to some instinctual behaviors of dogs and other pets, however, such structures do not have separate denning spaces, are not aesthetically complimentary for placement in human habitat and, further, do not provide a structured form that allows for the convenient placement of pet-friendly articles such as blankets and toys. In addition, such an enclosure collapses around the animal and greatly diminishes necessary venting of the animal space. A structure that provides more human-habitat friendliness are more likely to be used indoors as well as outdoors, bolstering sales as a result of its form. In yet another example, a pet containment system as disclosed in U.S. Pat. No. 5,664,524 to Piglia and Sileven, provides housing for small animals comprised of interconnected sectional units. Containment systems of this sort are cumbersome and require significant dismantling of the units in order to sufficiently clean all surfaces of the housing, and to retrieve animals from the enclosure.

### SUMMARY OF THE DISCLOSURE

In accordance with an aspect of the present disclosure, a pet shelter in the shape of a gastropod body, i.e., spiral shell, having aesthetic appeal that compliments instinctual behaviors of pets is provided. The pet shelter includes a generally narrow entryway that traverses a generally circular or spiral-shaped corridor which leads to and terminates at a nook bedding area, i.e., denning space. The pet shelter, in one embodiment of the present disclosure, is constructed of two attachable pieces—a bottom section (i.e., floor and bottom side) and a top section (i.e., roof and top side), however, alternatively, may be made of multiple pieces which, when assembled, form a gastropod spiral shell-shaped construction.

In another embodiment of the present disclosure, the pet shelter may be a configured as a one-piece construction made such as by molding or other forming and adhering means.

A pet shelter of the present disclosure as may be made of various materials to accommodate outdoor or indoor use, and constructed in various sizes to accommodate, for example stationary or transport use (such as a small crate), respectively. Furthermore, the top section may be configured of various heights whereby various top sections may be interchangeable with a bottom section to accommodate growth of a pet. In accordance with an aspect of an embodiment of the present disclosure, it is conceivable that a user may use top sections and bottom sections of a pet shelter that are interchangeable with other top sections and bottom sections, respectively. Similarly, a user may replace an entire pet shelter unit with a larger unit, if required or so desired.

In another aspect of an embodiment of the present disclosure, the pet shelter may have one or more hinges along the periphery separating the top section from the bottom section (in the case of two-piece construction) to allow a user to open the shelter for retrieving a pet, placing items such as removable bedding, toys, feeding stations, etc., and cleaning the shelter. The pet shelter may also include a series of clips or other attachment/locking means along the periphery for securing the top and bottom sections together.

In yet another aspect of the present disclosure, one or more opening structures (e.g., doors, gates, etc.) may be fashioned and situated within and/or along an interior and/or exterior surface of the pet shelter. Such openings, particularly in the case of a one-piece shelter construction, allows a user to open the shelter for retrieving a pet, placing items such as bedding, toys, feeding stations, etc. inside the shelter, and for cleaning the shelter. In addition, in accordance with various aspects of the present disclosure, flow adjustable venting doors may be situated along the surface of the pet shelter to control airflow (i.e., drafts) into and out of the interior of the shelter.

In a further aspect of the present disclosure, methods for managing and encouraging the instinctual behaviors (e.g., denning) of pets is provided. The methods include, for example, providing a shelter mimicking a cave-like dwelling for animals that is instinctually reminiscent of a safe and secure environment that may be found in nature. In addition, a pet shelter may include on any of its exterior surfaces one or more openings and/or adjustable vent holes (i.e., doors) for managing airflow and lighting into the shelter's space, thereby encouraging use by a pet.

In yet another aspect of the present disclosure, the pet shelter and method of use further includes altering the size of a pet shelter by replacing a top section of a shelter with another top section of greater height to accommodate growth of a pet, thereby maintaining habitat familiarity to encourage sustained use by a pet.

In yet a further aspect of the present disclosure, a method of use further includes providing a nook within a pet shelter to aid in house training and whelping.

In an alternative embodiment of the present disclosure, a pet shelter may be constructed of one or more sections of fabric-like material (e.g., stretchable plastic, cloth weave, rubber, tenting, etc.) attached to a frame structure configured/shaped as a gastropod shell with a spiral-shaped corridor and nook den space (not shown). The frame may be a collapsible structure providing space and weight savings for shipping the pet shelter. In addition, the fabric material may be constructed of a breathable fabric and configured to include flaps configured as doors for providing openings for venting, lighting, and the like. Such flaps may be configured for reveal by using, for example, zippers, Velcro or other fastening means.

Other features and aspects of this disclosure will be apparent from the following description and the accompanying drawings.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1A is a perspective view of a gastropod shell.

FIG. 1B is a planar view of the underside of a gastropod shell.

FIG. 2A is a perspective view of a gastropod pet shelter showing the entryway, exterior profile, spiral-shaped corridor (hidden line), and den space (hidden line), according to an embodiment of the present disclosure;

FIG. 2B is a perspective view of a gastropod pet shelter of FIG. 2A showing the top section opened and hingeably connected to the bottom section, further revealing the entryway, a den space, and a spiral-shaped corridor traversing from the entryway to the den space, according to an embodiment of the present disclosure;

FIG. 3 is a top view of the bottom section of a gastropod pet shelter showing the entryway, spiral-shaped corridor, and den space, including hinges and clips configured on the periphery of the bottom section, according to an embodiment of the present disclosure;

FIG. 4 are perspective views showing the top and bottom sections, including periphery, of a gastropod pet shelter further illustrating the interior of the gastropod pet shelter and further showing pet bedding and other items situated therein, according to an embodiment of the present disclosure;

FIGS. 5A and 5B are perspective views of prior art pet shelters; and

FIG. 6 is a perspective view of a gastropod pet shelter having a top section with a flat roof, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

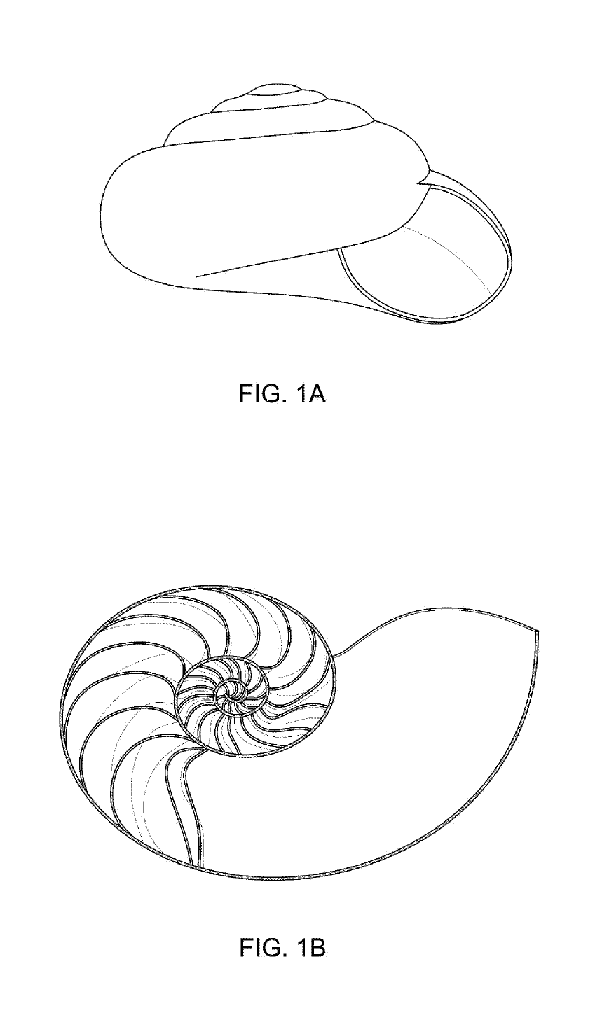

FIGS. 1A and 1B illustrates a typical shell shape of any of a large class (Gastropoda) of mollusks (such as snails and slugs) usually with a univalve coiled (i.e., spiral-shaped) shell. According to experts, the shell is an exoskeleton which provides protection from predators and mechanical damage to the interior of the shell. In accordance with various embodiments of the present disclosure, exterior and interior features of gastropod shells, as illustrated, offer advantages for sheltering animals that are instinctually driven to seek refuge in cave-like dwellings.

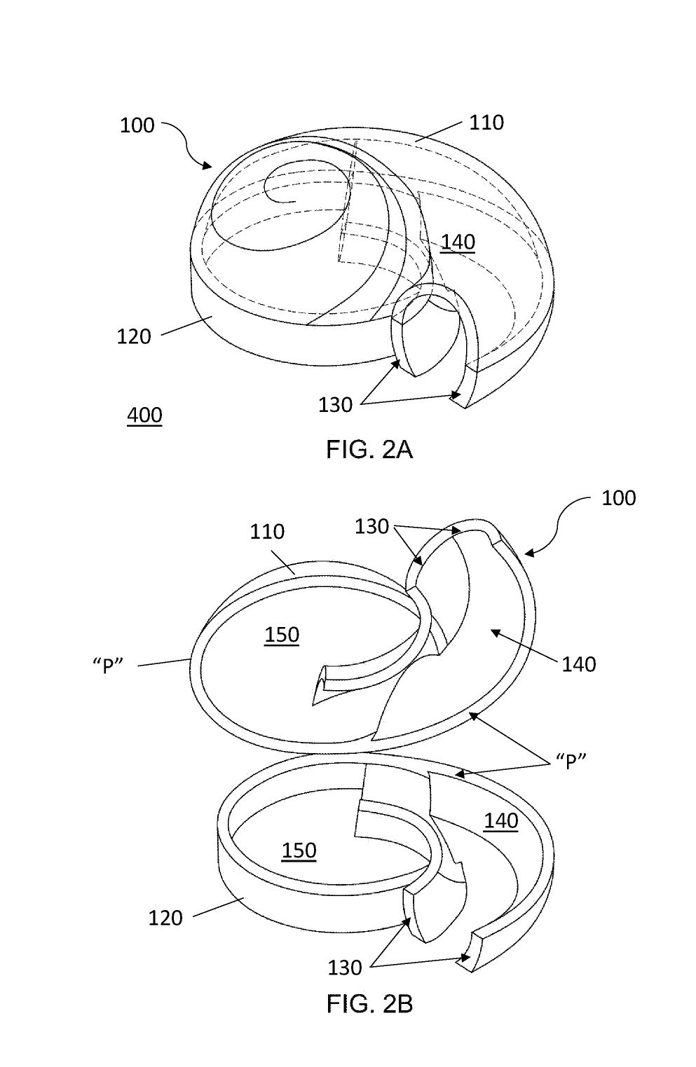

FIGS. 2A and 2B illustrate a pet shelter 100 constructed in the shape of a gastropod-like spiral-shaped shell including a top section 110, a bottom section 120, an entryway 130, a spiral-shaped corridor 140, and a den area 150, according to an embodiment of the present disclosure. The pet shelter 100 includes one or more fasteners and/or hinges 200 along the periphery “P” to facilitate attaching, closing, and/or opening, respectively, the top section 110 relative to/from the bottom section 120. The pet shelter 100 may be placed on a surface 400, such as a floor or table top.

The pet shelter 100 is used to provide a cave-like dwelling for a pet, such as a dog, cat, rabbit, etc. that compliments their natural instinct to generally seek shelter in small, dark, draft-free nooks for denning. Pet shelter 100 simulates a cave-like structure for a pet habitat by providing an entryway 130 which traverses a generally narrow spiral-shaped corridor 140 which leads to a den area 150. Den area 150 may include, for example, bedding 160, blanket(s), toy(s), or other items 170 for a pet or user. In an aspect of the present disclosure, a pet shelter 100 allows a user the ability to provide removable bedding 160 and toys or other items, such as a blanket, 170 to a pet shelter 100.

By reference to FIGS. 2B and 4, the pet shelter 100, according to an exemplary embodiment of the present disclosure, is constructed of two pieces—a top section 110 and a bottom section 120—hinged together by fastener 200 to allow opening/closing of the top section 110 or bottom section 120, relative to each other. It is contemplated that the function of hinge 200 may be accomplished, alternatively, by other attachment means such as a strap and buckle (not shown) configured onto the top section 110 and the bottom section 120, respectively. In accordance with an embodiment of the present disclosure, a pet shelter 100 is not limited to a two-piece construction comprised of a top section 110 and a bottom section 120. Construction of a pet shelter 100 may, alternatively, be constructed of multiple pieces attached or otherwise bonded together that results in a gastropod-like spiral-shaped shell including an entryway 130 which traverses a generally narrow spiral-shaped corridor 140 leading to a den area 150. Likewise, a pet shelter 100, according to an embodiment of the present disclosure, may be a one-piece construction using manufacturing techniques such as blow molding a thermoplastic preform or parison inside a closed mold so its shape conforms to that of pet shelter 100.

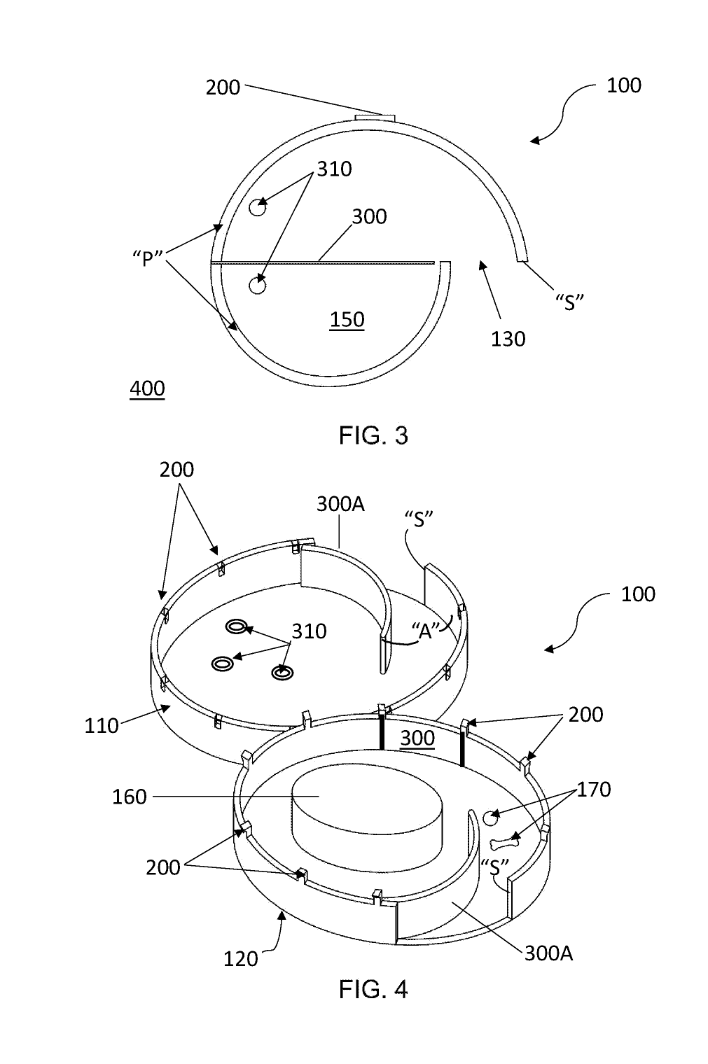

FIG. 3 is a top view of a bottom section 120 of a pet shelter 100, according to an embodiment of the present disclosure, and illustrates entryway 130, corridor 140, and den 150. FIG. 3 also shows exemplary placement of gates or doors 300 and vents or lighting doors 310 situated thereon. Gates or doors 300 may be situated anywhere within the interior of the pet shelter 100 to provide, for example, closed off passages within the interior of the pet shelter 100 and/or to provide access to the interior of the pet shelter 100 from the outside. In an aspect of the exemplary embodiment, gate/door 300A moves along arc “A” to contact surface “S” to close off access to pet shelter 100.

Vents or lighting doors 310 may be situated anywhere on the interior or exterior surface (including top section 110 and bottom section 120) of a pet shelter 100 to provide a user the ability to control light and/or airflow into the interior of a pet shelter 100. Gates or doors 300 may be formed and removably attached to the interior of the pet shelter 100 or entryway 130 on hinges (not shown) or as pocket doors (not shown), respectively. Gates or doors 300, 300A and vents or lighting doors 310 may be integrally formed with the top section 110 and bottom section 120 of a pet shelter 100.

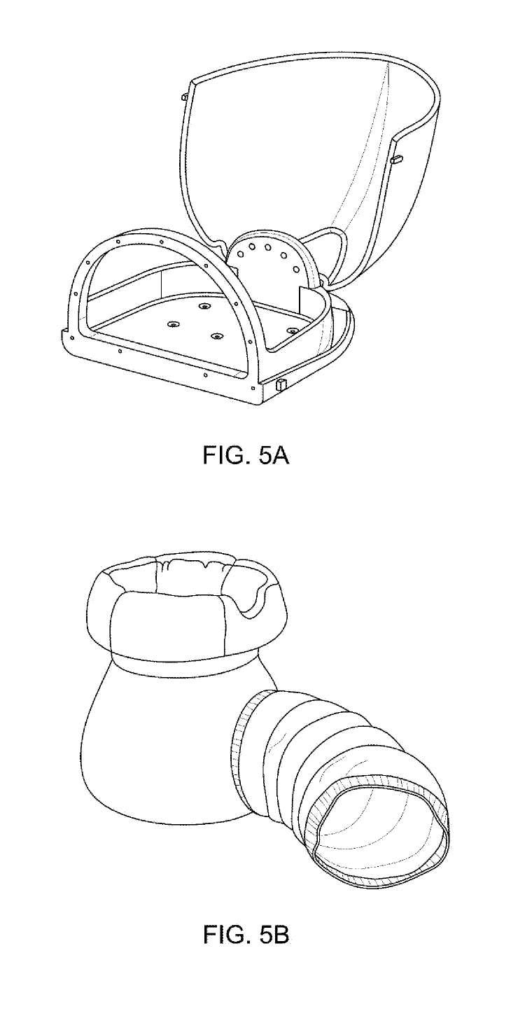

FIGS. 5A and 5B illustrate pet shelters of the prior art. The prior art pet shelter as illustrated in FIG. 5A leaves a pet exposed to outside elements such as drafts and light without further refuge to a nooked den. Likewise, the prior art pet shelter, as shown in FIG. 5B, provides an entryway; however, the entryway is of a construction that is difficult to clean and not formed integrally with the animal's den space. In addition, the entryway, not being integral adds to the number of pieces and cost of the pet shelter.

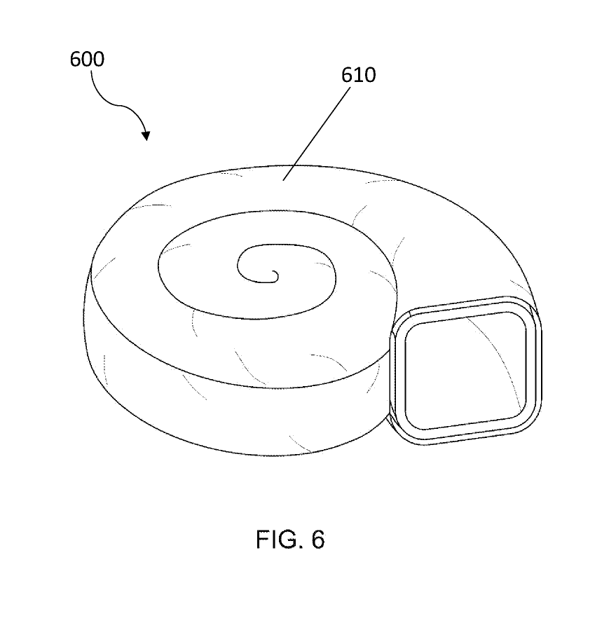

FIG. 6 illustrates an alternative embodiment of a pet shelter 600, where a pet shelter 600 (otherwise including the exemplary features of pet shelter 100) may be constructed using a flat roof 610. In an aspect of the present disclosure, flat roof 600 aids a user's ability to stack multiple pet shelters 600 atop each other.

A pet shelter 100, according to an embodiment of the present disclosure, provides a user the ability to adjust its size for a growing pet by replacing a top section 110 with a top section 110 of greater height. In addition, experts cite that household pets, and dogs in particular, accept enclosed boxes for sanctuary and generally will not soil this bedding area. A user may simulate the habitat of a dog in its wild state using a pet shelter 100 to aid in house training as den 150 provides a pet sanctuary. Furthermore, a pet shelter 100 may be used as a whelping box to provide a pet means for protecting puppies during birth, assuring safe containment of puppies (e.g., in den area 150), while also protecting puppies from adverse weather and temperatures.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims. It is also understood by those of skill in the art that terms pet and animal may be used interchangeably, and that holes are defined by opening structures (e.g., doors) without departing from the scope of the invention.
100 Pet shelter
110 Top section
120 Bottom section
130 Entryway
140 Spiral-shaped corridor
150 Den area
160 Bedding
170 Blankets, toys, etc.
200 Fastener or hinges
300 Gates or doors
300A Gate or door
310 Vents or lighting doors
400 Surface (e.g., floor)
500 Prior art pet shelter
510 Prior art shelter
600 Pet shelter, flat roof
610 Flat roof
“P” Periphery
“S” Closure surface

What is claimed is:

1. A pet shelter for exploiting the instinctual behavior of animals, the pet shelter comprising:
a structure having generally exterior and interior features of a gastropod shell, wherein the features comprises an opening at an end of said structure defining an entryway configured to receive a pet;
a spiral-shaped corridor traversing an interior space of the structure; and
a den disposed within the interior space of the structure at the termination of the corridor.

2. The pet shelter of claim 1 wherein said structure comprises:
a top section and a bottom section, each removably coupled to the other, and forming a structure having exterior and interior features of a gastropod shell, wherein the features comprises an opening defining an entryway configured to receive an animal;
a spiral-shaped corridor traversing an interior space of the structure; and
a den disposed within the interior space of the structure, the den connected to the end of the corridor.

3. The pet shelter of claim 1 wherein the structure includes one or more doors and/or gates configured within the interior and/or exterior of the structure.

4. The pet shelter of claim 2 wherein the top section and the bottom section are constructed as a one-piece contiguous structure.

5. The pet shelter of claim 2 wherein the top section and/or the bottom section include one or more air vents and/or lighting doors.

6. The pet shelter of claim 1 wherein the structure comprises:
a fabric material comprising one or a plurality of fabric sections;
a framing structure having generally exterior and interior skeletal features of a gastropod shell, wherein the features comprises an opening at an end of said structure defining an entryway configured to receive a pet;
a framing structure defining a spiral-shaped corridor forming and traversing an interior space of the structure; and
a den disposed within the framed interior space of the structure at the termination of the corridor.

7. The pet shelter of claim 2 wherein means for opening said top section with respect to said bottom section comprises one or more hinges each of which is configured on said top and bottom sections, respectively.

8. The pet shelter of claim 2 wherein means for attaching the top section to a bottom section comprises one or more attachment means configured integral with the periphery of the structure.
